(19) United States
(12) Patent Application Publication
(10) Pub. No.: US 2022/0062077 A1
(43) Pub. Date: Mar. 3, 2022

(54) METHODS AND APPARATUSES FOR CONTROLLING A POWERED MOBILITY DEVICE

(71) Applicant: TOYOTA MOTOR NORTH AMERICA, INC., Plano, TX (US)

(72) Inventors: Douglas A. Moore, Fairview, TX (US); Paul Ellsworth Nichols, Healdsburg, CA (US); Thomas Mitchell Dair, Lafayette, CA (US)

(73) Assignee: TOYOTA MOTOR NORTH AMERICA, INC., Plano, TX (US)

(21) Appl. No.: 17/002,334

(22) Filed: Aug. 25, 2020

(51) Int. Cl. A61G 5/04; B62D 51/04; B62D 51/00; A61H 3/04

(52) U.S. Cl. CPC A61G 5/048; B62D 51/04; B62D 51/001; A61G 2203/10; A61H 2003/043; A61H 2201/1635; A61H 2201/5025; A61H 3/04

(57) ABSTRACT

A powered mobility device comprises two powered wheels, a controller, and a control handle configured to generate control signals in response to being operated by push and pull inputs from a user. The control handle rotates between a first operating position and a second operating position such than an orientation of the control handle is reversed with respect to a forward movement direction of the mobility device. The controller is configured to control the powered wheels of the mobility device to move in the forward movement direction in response the control handle being operated in the forward movement direction and move in a reverse movement direction in response to the control handle being operated in the reverse movement direction in both the first operating position and the second operating position regardless of the reversed orientation of the control handle.

### TECHNICAL FIELD

The present specification generally relates to apparatuses and methods for controlling movement of a mobility device and, more specifically, apparatuses and methods for providing a consistent control scheme for control handles in different operating positions of a multi-functional mobility device.

### BACKGROUND

People in need of physical assistance require mobility devices to perform everyday tasks, such as moving from one place to another. A person may use a wheelchair to travel but may also have some capability of walking with a walker device. However, each of these mobility devices is bulky and takes up valuable space. When traveling away from home a user may not have the option of bringing both a wheelchair and a walker device.

Some mobility devices transform between different modes, such as a wheelchair and a walker. However, transforming between a wheelchair mode and a walker mode may involve repositioning the control interface. In addition, the direction that a user faces, relative to the multi-function mobility device, is reversed for the walker mode versus the wheelchair mode. This repositioning of the control interface and reversal of the user's position can introduce some changes into the user's interaction with the control interface, requiring counter-intuitive adjustments on the part of the user.

Accordingly, a need exists for methods and apparatuses for providing a consistent control scheme for control handles in different operating positions of a multi-functional mobility device.

### SUMMARY

In one embodiment, a powered mobility device may include two powered wheels, a control handle, and a controller. The control handle may be configured to generate control signals in response to being operated by push and pull inputs from a user, and rotate between a first operating position and a second operating position such that an orientation of the control handle is reversed with respect to a forward movement direction of the mobility device. The controller may be configured to control the powered wheels of the mobility device to move in the forward movement direction in response to the control handle being operated in the forward movement direction and move in a reverse movement direction in response to the control handle being operated in the reverse movement direction in both the first operating position and the second operating position regardless of the reversed orientation of the control handle.

In another embodiment, the control signals include a first control signal and a second control signal, and the control handle is configured to send the first control signal in response to being operated in the forward movement direction, and send the second control signal in response to being operated in the reverse movement direction. In the second operating position, the control handle is configured to send the first control signal in response to being operated in the reverse movement direction, and send the second control signal in response to being operated in the forward movement direction.

In another embodiment, the controller may be further configured to control the powered wheels of the mobility device to move in the forward movement direction in response to receiving the first control signal from the control handle in the first operating position. The controller may be further configured to control the powered wheels of the mobility device to move in the reverse movement direction in response to receiving the first control signal from the control handle in the second operating position. The controller may be further configured to control the powered wheels of the mobility device to move in the reverse movement direction in response to receiving the second control signal from the control handle in the first operating position. The controller may be further configured to control the powered wheels of the mobility device to move in the forward movement direction in response to receiving the second control signal from the control handle in the second operating position.

In another embodiment, the control signals further include a third control signal, and the control handle may be further configured to send the third control signal in response to rotation between the first operating position and the second operation position. The controller may be further configured to detect the third control signal and respond to the first control signal and the second control signal according to the operating position indicated by the third control signal.

In another embodiment, the powered mobility device further includes a control handle assembly that includes the control handle. The control handle assembly includes a first configuration point configured to rotate on a first axis, a second configuration point configured to rotate on a second axis, and a third configuration point configured to rotate on a third axis.

In another embodiment, the powered mobility device includes a multi-function mobility device configured to operate in a wheelchair mode, operate in a walker mode, and transform between the wheelchair mode and the walker mode. The transformation includes a rotation of the control handle on the first axis, a rotation of the control handle on the second axis, and a rotation of the control handle on the third axis.

In another embodiment, the control handle includes a pressure sensor and is further configured to generate the control signals in response to pressure applied to the control handle.

In another embodiment, the control handle is further configured to move in response to the push and pull inputs from the user and generate the control signals in response to the movement of the control handle.

In yet another embodiment, a method for controlling movement of a powered mobility device may include detecting a change in operating position of a control handle of a powered mobility device, and controlling the mobility device to move in a forward movement direction in response to a first control signal and a reverse movement direction in response to a second control signal. The method may further include, in response to a change in the detected operating position of the control handle, controlling the mobility device to move in the reverse movement direction in response to the first control signal and the forward movement direction in response to the second control signal.

In another embodiment, the method further includes receiving control signals from the control handle in response to the control handle being operated by push and pull inputs from a user. The detecting of the change in operating position of the control handle may include detecting rotation of the control handle such that an orientation of the control handle is reversed with respect to a forward movement direction of the mobility device.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a controller configured to receive inputs and control the powered wheels of a mobility device;

FIG. 2A depicts a multi-function mobility device including control handles configured for a wheelchair mode according to one or more embodiments shown and described herein;

FIG. 2B depicts a multi-function mobility device including control handles configured for a walker mode according to one or more embodiments shown and described herein; and

FIG. 3 depicts control handles of a mobility device according to one or more embodiments shown and described herein.

### DETAILED DESCRIPTION

Embodiments disclosed herein are applicable to a control system for a multi-function mobility device. The multi-function mobility device may transform between a wheelchair mode and a walker mode. The disclosed embodiments maintain a consistent control scheme using the same set of input controls even while a user faces a different direction in different modes of the multi-function mobility device. When transforming the multi-function mobility device between a wheelchair and a walker mode, the orientation of the input controls, relative to the mobility device, may be rearranged. A controller is configured to detect the orientation of the input controls and adjust interpretation of the control signals received from the input controls so that movement of the multi-function mobility device is aligned with the direction of inputs to the input controls.

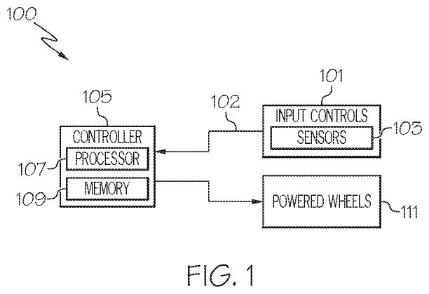

FIG. 1 depicts a system 100 for receiving inputs and controlling the motion of a mobility device. A mobility device may be any powered or non-powered device that assists in human mobility, including a wheelchair, a walker, a scooter, or personal transporter. A mobility device need not be specifically intended for use by disable people. According to an embodiment, the system 100 comprises input controls 101, a controller 105, and powered wheels 111. According to an embodiment, the controller 105 comprises a processor 107 and memory 109. The processor 107 and memory 109 may be configured to store, read, and execute computer-readable instructions that cause the controller 105 to control the motion of the powered wheels 111 based on control signals received from the input controls 101 according to a control scheme. The control scheme may define how inputs to the input controls 101 are translated into motion of the mobility device.

The input controls 101 may comprise sensors 103 configured to detect user inputs to the input controls 101 and generate control signals 102 based on the detected user inputs. As a non-limiting example, the sensors 103 may comprise displacement sensors and the input controls 101 may be configured to displace from a neutral position in response to inputs from a user. As another non-limiting example, the sensors 103 may comprise pressure sensors configured to detect pressure placed on the control inputs 101 by a user. The controller 105 may be configured to implement the same control scheme whether the sensors 103 are configured to detect displacement in response to user inputs or configured to detect pressure in response to user inputs.

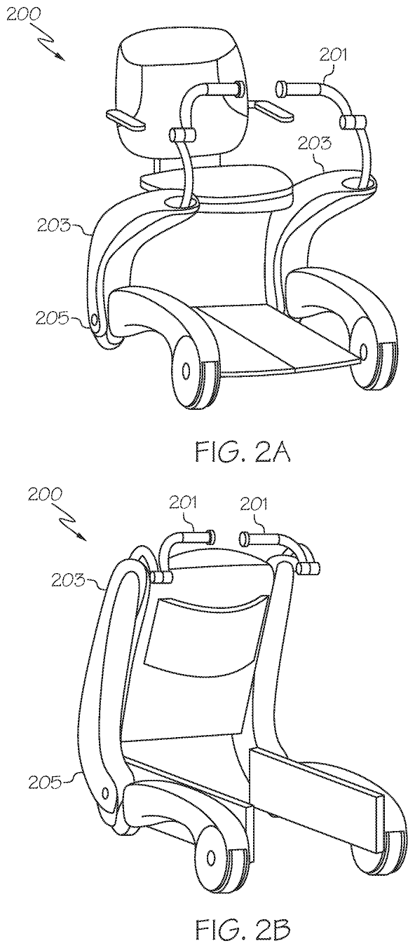

FIG. 2A illustrates an example multi-function mobility device including control handles configured for a wheelchair mode and FIG. 2B illustrates the example multi-function mobility device including control handles configured in a walker mode according to one or more embodiments shown and described herein. The multi-function mobility device 200 comprises one or more control handle assemblies 201, each attached to a support arm 203 of the multi-function mobility device 200. In some embodiments, the input controls 101 may be incorporated into the control handle assemblies 201. In embodiments, the support arm 203 is configured to rotate, at a rotation point 205, between a first position in the wheelchair mode (FIG. 2A) and a second position in the walker mode (FIG. 2B). In the wheelchair mode, the control handle assemblies 201 are configured in a first operating position, shown in FIG. 2A. In the walker mode, the control handle assemblies 201 are configured in a second operating position shown in FIG. 2B. According to one or more embodiments, the controller 105 is configured to maintain the same control scheme, from the perspective of the user, in both the first operating position and the second operating position.

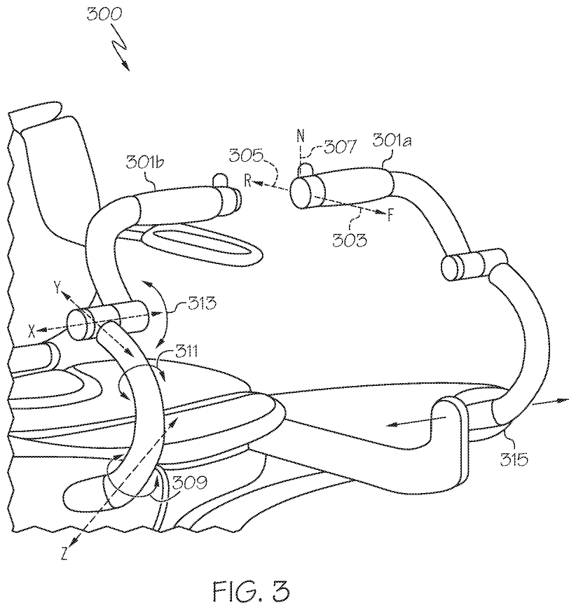

FIG. 3 generally depicts one embodiment of control interface 300 on a mobility device. In the illustrated example embodiment, the control interface includes input controls 101 incorporated into control handles 301A, 301B. Other input controls, such as joysticks, levers, twist grips, or pedals, may also be used without departing from the spirit and scope of the disclosed embodiments. In the embodiments described herein, the control interface 300 includes a pair of control handles 301A, 301B for illustrative purposes only. However, the principles and methods described apply equally to a single control handle. The control handles 301A, 301B are configured to receive user input corresponding to a forward movement direction 303, a reverse movement direction 305, and neutral 307 for no movement. The control handles may also be configured to swing at a hinge point 315 in order to allow the user to more easily enter and exit the mobility device.

The mobility device is configured to move or turn in response to user inputs to the input controls 301A, 301B, according to a control scheme. The control scheme defines how user inputs to the input controls 301A, 301B are translated into motion of the mobility device. For example, in response to neutral 307 input, the mobility device may be configured to stop. Alternatively, the mobility device may be configured to freewheel in response to a neutral 307 input. In the illustrated embodiment, the input controls comprise a left control handle 301A and a right control handle 301B. The mobility device may be configured to move in the forward motion direction 303 in response to the left control handle 301A and the right control handle 301B both receiving inputs in the forward motion direction. Likewise, the mobility device may be configured to move in the reverse motion direction 305 in response to the left control handle 301A and the right control handle 301B both receiving inputs in the reverse motion direction 305.

The mobility device may be further configured to turn in response to receiving different inputs at the left control handle 301A and right control handle 301B. As a non-limiting example, when the left control handle 301A receives an input in the forward motion direction 303, and the right control handle 301B remains in the neutral 307 or receives an input in the reverse motion direction 305, the mobility device turns right. Conversely, when the right control handle 301B receives an input in the forward motion direction 303, and the left control handle 301A remains in the neutral 307 or receives an input in the reverse motion direction 305, the mobility device turns left. This control scheme is known as a “zero-turn” control scheme.

FIG. 3 also includes X, Y, and Z coordinate axes in order to facilitate explanation of the reconfiguring the control handles 301A, 301B between the first operating position (FIG. 2A) and the second operating position (FIG. 2B). However, the X, Y, and Z axes are not necessarily aligned with the forward motion direction 303 or the reverse motion direction 305. In embodiments, the control handle assembly may be configured to rotate at a first configuration point 309, a second configuration point 311, and a third configuration point 313. In one non-limiting example, the reconfiguration of the control handles 301A, 301B from the first operating position (FIG. 2A) to the second operating position (FIG. 2B) may involve rotating the control handle assembly about 180 degrees around a Z axis at the first configuration point 309, rotating about 180 degrees around a Y axis at the second configuration point 311, and rotating the control handle 301b 45-180 degrees around an X axis at the third configuration point.

Reconfiguring the mobility device may have a subtle effect on the way the control interface interprets user inputs. In understanding this effect, it is useful to think of the forward motion direction 303 and reverse motion direction 305 as directions relative to the mobility device. In the first operating position (FIG. 2A), the mobility device is in a wheelchair mode, and a user input to the control handles 301A, 301B in the forward motion direction 303 may produce a first control signal, while a user input to the control handles 301A, 301B in the reverse motion direction 305 may produce a second control signal. The controller 105 is configured to receive the control signals and cause the appropriate motion of the mobility device by controlling the direction of the powered wheels 111. However, because of the rotations involved in transforming to the second operating position (FIG. 2B), the control handles 301A, 301B, may have a different orientation relative to the mobility device. In the second operating position (FIG. 2B), the control handles 301A, 301B may generate the first control signal in response to a user input in the reverse motion direction 305 and generate the second control signal in response to user input in the forward motion direction 303. This can create a counter-intuitive change in the control scheme of the mobility device.

Referring again to FIG. 1, the controller 105 may be configured to detect the first operating position and the second operating position. In the first operating position (FIG. 2A), the controller 105 is configured to control the powered wheels 111 to move the mobility device in the forward motion direction 303 in response to receiving the first control signal. In the second operating position (FIG. 2B), the controller 105 is configured to control the powered wheels 111 to move the mobility device in the reverse motion direction 305 in response to receiving the first control signal. Similarly, in the first operating position (FIG. 2A), the controller 105 is configured to control the powered wheels 111 to move the mobility device in the reverse motion direction 305 in response to receiving a second control signal. In the second operating position (FIG. 2B), the controller 105 is configured to control the powered wheels 111 to move the mobility device in the forward motion direction 303 in response to receiving the second control signal. This ensures that, from the perspective of the user, an input to the control handles 301A, 301B in the forward motion direction 303 always moves the mobility device intuitively in the forward motion direction 303 and an input to the control handles 301A, 301B in the reverse motion direction 305 always moves the mobility device intuitively in the reverse motion direction 305.

According to an embodiment, the control handles 301A 301B are configured to generate a third control signal that indicates the configuration of the control handles 301A, 301B. The controller may be configured to detect the operating position of the control handles 301A, 301B, using the third control signal, and change the direction of the powered wheels in response to the control signals generated by the control handles 301A, 301B. The table below describe the direction of wheel motion produced by the controller in response to the first control signal and second control signal, based on the third control signal.

TABLE 1

| First control signal | Second control signal | Third control signal |
|---|---|---|
| Forward | Reverse | First operating position |
| Reverse | Forward | Second operating position |

It should now be understood that embodiments described here are directed to systems and methods for maintaining a consistent intuitive control scheme for input controls of a multi-function mobility device that transforms between multiple operating modes, such as a wheelchair mode and a walker mode.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A powered mobility device comprising:
two powered wheels;
a control handle configured to:
generate control signals in response to inputs from a user, and
rotate between a first operating position and a second operating position such that an orientation of the control handle is reversed with respect to a forward movement direction of the powered mobility device, and
a controller configured to control the powered wheels of the powered mobility device to move in the forward movement direction in response to the control handle being operated in the forward movement direction and move in a reverse movement direction in response to the control handle being operated in the reverse movement direction in both the first operating position and the second operating position regardless of the reversed orientation of the control handle.

2. The powered mobility device of claim 1, wherein the control signals comprise a first control signal and a second control signal,
wherein, in the first operating position, the control handle is configured to:
send the first control signal in response to being operated in the forward movement direction, and
send the second control signal in response to being operated in the reverse movement direction; and
wherein, in the second operating position, the control handle is configured to:
send the first control signal in response to being operated in the reverse movement direction, and
send the second control signal in response to being operated in the forward movement direction.

3. The powered mobility device of claim 2, wherein the controller is further configured to:
in response to receiving the first control signal from the control handle in the first operating position, control the powered wheels of the powered mobility device to move in the forward movement direction;
in response to receiving the first control signal from the control handle in the second operating position, control the powered wheels of the powered mobility device to move in the reverse movement direction;
in response to receiving the second control signal from the control handle in the first operating position, control the powered wheels of the powered mobility device to move in the reverse movement direction; and
in response to receiving the second control signal from the control handle in the second operating position, control the powered wheels of the powered mobility device to move in the forward movement direction.

4. The powered mobility device of claim 3, wherein the control signals further comprise a third control signal, and
wherein the control handle is configured to send the third control signal in response to rotation between the first operating position and the second operation position; and
wherein the controller is further configured to detect the third control signal and respond to the first control signal and the second control signal according to the operating position indicated by the third control signal.

5. The powered mobility device of claim 1 further comprising:
a control handle assembly, the control handle assembly comprising:
the control handle;
a first configuration point configured to rotate on a first axis;
a second configuration point configured to rotate on a second axis; and
a third configuration point configured to rotate on a third axis;

6. The powered mobility device of claim 5, wherein the powered mobility device comprises a multi-function powered mobility device configured to:
operate in a wheelchair mode;
operate in a walker mode; and
transform between the wheelchair mode and the walker mode,
wherein the transformation comprises a rotation of the control handle on the first axis, a rotation of the control handle on the second axis, and a rotation of the control handle on the third axis.

7. The powered mobility device of claim 1, wherein the control handle comprises a pressure sensor and is further configured to generate the control signals in response to pressure applied to the control handle.

8. The powered mobility device of claim 1, wherein the control handle is further configured to:
move in response to the inputs from the user; and
generate the control signals in response to the movement of the control handle.

9. A method for controlling movement of a powered powered mobility device, the method comprising:
detecting a change in operating position of a control handle of a powered powered mobility device;
controlling the powered mobility device to move in a forward movement direction in response to a first control signal and a reverse movement direction in response to a second control signal;
in response to a change in the detected operating position of the control handle, controlling the powered mobility device to move in the reverse movement direction in response to the first control signal and the forward movement direction in response to the second control signal.

10. The method of claim 5, further comprising:
receiving control signals from the control handle in response to the control handle being operated by push and pull inputs from a user,
wherein the detecting of the change in operating position of the control handle comprises detecting rotation of the control handle such that an orientation of the control handle is reversed with respect to a forward movement direction of the powered mobility device.
